(19) United States
(12) Patent Application Publication
(10) Pub. No.: US 2026/0327417 A1
(43) Pub. Date: Oct. 22, 2026

(54) Two-Part Compositions Including Self-Polymerizable Toughening Agent, and Methods of Using Same

(71) Applicant: 3M INNOVATIVE PROPERTIES COMPANY, St. Paul, MN (US)

(72) Inventors: Boris O.A. Tasch, Dusseldorf (DE); Dirk Hasenberg, Raeren (BE); Wayne S. Mahoney, St. Paul, MN (US)

(21) Appl. No.: 18/998,677

(22) PCT Filed: Jul. 18, 2023
(86) PCT No.: PCT/IB2023/057324

§ 371 Date: Jan. 27, 2025

Related U.S. Application Data
(60) Provisional application No. 63/399,792, filed on Aug. 22, 2022.

(51) Int. Cl. C08L 63/00; C08G 59/50; C09J 5/00; C09J 163/00

(52) U.S. Cl. CPC C08L 63/00; C08G 59/50; C09J 5/00; C09J 163/00; C08G 2170/00

(57) ABSTRACT

Provided are two-part compositions for forming structural adhesive compositions including epoxy resin, a curing agent, and toughening agents, in which the epoxy resin and curing agent are present in separate parts. One of the toughening agents includes a free-radically self-polymerizable material. Additionally, methods of bonding together two parts are provided.

### TECHNICAL FIELD

The present disclosure generally relates to two-part curable compositions including toughening agents, cured compositions, and related methods.

### BACKGROUND

Structural adhesives are known to be useful for bonding one substrate to another, e.g., a metal to a metal, a metal to a plastic, a plastic to a plastic, a glass to a glass. Structural adhesives are attractive alternatives to mechanical joining methods, such as riveting or spot welding, because structural adhesives distribute load stresses over larger areas rather than concentrating such stresses at a few points. Structural adhesives may also produce cleaner and quieter products because they can dampen vibration and reduce noise. Additionally, structural adhesives can be used to bond a variety of materials, sometimes without extensive surface preparation.

### SUMMARY

In first aspect, a two-part composition is provided. The two-part composition comprises:
(1) a first part comprising:
   an epoxy resin;
   optionally a first toughening agent; and
   optionally a second toughening agent comprising a free-radically self-polymerizable material represented by the formula:

$${LR}_{q}^{1}$$

wherein each R¹ is independently selected from a functional group represented by the formula:

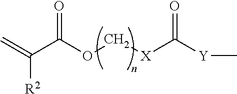

wherein:
   each R² is independently hydrogen or methyl;
   n is an integer from 1 to 5, inclusive;
   X is O, S, or NH; and
   Y is a single bond or a divalent group represented by the formula:

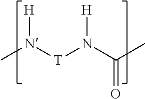

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is a q-valent organic polymer comprising a monomer unit represented by the formula:

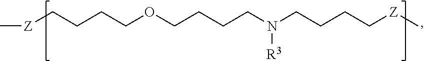

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH; and
(2) a second part comprising:
   a curing agent for the epoxy resin;
   optionally the first toughening agent; and
   optionally the second toughening agent,
with the provisos that the first toughening agent is present in at least one of the first part or the second part and the second first toughening agent is present in at least one of the first part or the second part.

In second aspect, a method of bonding two parts is provided. The method comprises:
a) obtaining the two-part composition according to the first aspect;
b) combining at least a portion of the first part of the two-part composition with at least a portion of the second part of the two-part composition to form a mixture;
c) applying the mixture to a surface of at least one of the two parts; and
d) joining the two parts so that the mixture is positioned between the two parts; and
e) initiating the curing agent for the epoxy resin, thereby obtaining a substantially fully cured structural adhesive composition and bonding the two parts.

Features and advantages of the present disclosure will be further understood upon consideration of the detailed description as well as the appended claims.

### DETAILED DESCRIPTION

### Glossary

The term “alkyl” refers to a monovalent group that is a radical of an alkane, which is a saturated hydrocarbon. The alkyl can be linear, branched, cyclic, or combinations thereof and typically has 1 to 20 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. The radical centers of the alkylene can be on the same carbon atom (i.e., an alkylidene) or on different carbon atoms.

The term “alkoxy” refers to a monovalent group of formula-OR where R is an alkyl.

The term “arylene” refers to a polyvalent, aromatic, such as phenylene, naphthalene, and the like.

The term “heteroalkylene” refers to an alkylene having one or more —CH₂— groups replaced with a thio, oxy, or —NR^{b}— where R^{b} is hydrogen or alkyl. The heteroalkylene can be linear, branched, cyclic, or combinations thereof. Exemplary heteroalkylene include alkylene oxides or poly(alkylene oxides). That is, the heteroalkylenes include at least one group of formula —(R—O)— where R is an alkylene.

The term “(meth)acrylate” or “(meth)acrylic acid” is used herein to denote the corresponding acrylate and methacrylate. Thus, for instance, the term “(meth)acrylic acid” covers both methacrylic acid and acrylic acid, and the term “(meth)acrylate” covers both acrylates and methacrylates. The (meth)acrylate or the (meth)acrylic acid may consist only of the methacrylate or methacrylic acid, respectively, or may consist only of the acrylate or the acrylic acid, respectively, yet may also relate to a mixture of the respective acrylate and methacrylate (or acrylic acid and methacrylic acid).

In the context of the present disclosure, the expression “free-radically self-polymerizable compound” is meant to refer to a compound able to form a polymeric product (homopolymer) resulting from the free-radically-induced polymerization of the compound almost exclusively with itself, thereby forming a homopolymer. In some cases, radiation exposure is used in the generation of free radicals. The term “homopolymer” is herein meant to designate polymer(s) resulting exclusively from the polymerization of a single type of monomers.

In the context of the present disclosure, the expression “the thermally curable resins are substantially uncured” is meant to designate that less than 10 wt. %, less than 5 wt. %, less than 2 wt. %, or even less than 1 wt. % of the initial curable resins are unreacted.

The terms “glass transition temperature” and “Tg” are used interchangeably and refer to the glass transition temperature of a (co) polymeric material or a mixture of monomers and polymers. Unless otherwise indicated, glass transition temperature values are determined by Differential Scanning Calorimetry (DSC).

The phrase “comprises at least one of” followed by a list refers to comprising any one of the items in the list and any combination of two or more items in the list. The phrase “at least one of” followed by a list refers to any one of the items in the list or any combination of two or more items in the list.

As used herein, the term “and/or” is used to indicate one or both stated cases may occur, for example A and/or B includes, (A and B) and (A or B).

As used herein, the term “room temperature” refers to a temperature in the range of 20° C. to 25° C.

Epoxy adhesives are widely used structural adhesives having not only certain desirable mechanical properties but also a high resistance towards chemicals and aging. However, epoxy adhesives also tend to be rather brittle, which makes it necessary to further toughen them. These toughening agents or tougheners are typically based on the concept of phase separation within the epoxy matrix. Depending on the curing cycle, toughening can be achieved in-situ during a heat cure by using different polarities of polymers for example, or by introduction of separated phases in a form of core-shell rubber particles. For example, block-copolymers with epoxy end groups may be suitable as toughening agents.

It was unexpectedly discovered that the inclusion of a toughening agent comprising a self-polymerization reaction product of a free-radically self-polymerizable material represented by the formula LR¹_{q} as described in the present disclosure showed improved impact peel toughness not only at room temperature but also at −30° C. Vehicles (e.g., automobiles) may be used at such low ambient temperatures, thus higher impact peel toughness at low temperatures is desirable. It was further discovered that this increase in impact peel toughness occurs even if the toughening agent is not crosslinked prior to the heat cure of the epoxy adhesive.

### Two-Part Compositions

In first aspect, a two-part composition is provided. The two-part composition comprises:
(1) a first part comprising:
   an epoxy resin;
   optionally a first toughening agent; and
   optionally a second toughening agent comprising a free-radically self-polymerizable material represented by the formula:

$${LR}_{q}^{1}$$

wherein each R¹ is independently selected from a functional group represented by the formula:

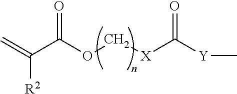

wherein:
   each R² is independently hydrogen or methyl;
   n is an integer from 1 to 5, inclusive;
   X is O, S, or NH; and
   Y is a single bond or a divalent group represented by the formula:

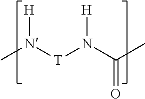

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
   q is an integer of at least 2; and
   L is a q-valent organic polymer comprising a monomer unit represented by the formula:

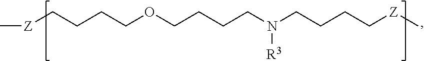

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH; and
(2) a second part comprising:
   a curing agent for the epoxy resin;
   optionally the first toughening agent; and
   optionally the second toughening agent,
with the provisos that the first toughening agent is present in at least one of the first part or the second part and the second first toughening agent is present in at least one of the first part or the second part.

Two-part compositions of the present disclosure may be prepared by methods known to those of ordinary skill in the relevant arts. Each of the components of the two-part composition is described in detail below.

### Epoxy Resins

The first part of a two-part composition (e.g., for forming a structural adhesive) contains an epoxy resin. Epoxy resins are well known to those skilled in the art of structural adhesive compositions. Suitable epoxy resins for use herein and their methods of manufacturing are amply described for example in EP-A1-2 700 683 (Elgimiabi et al.) and in WO 2017/197087 (Aizawa). Exemplary epoxy resins for use herein may be advantageously selected from the group consisting of phenolic epoxy resins, bisphenol epoxy resins, hydrogenated epoxy resins, aliphatic epoxy resins, halogenated bisphenol epoxy resins, novolac epoxy resins, and any mixtures thereof. The epoxy resin for use in the present disclosure often comprises glycidyl groups.

In some cases, the epoxy resin is selected from the group consisting of novolac epoxy resins, bisphenol epoxy resins, in particular those derived from the reaction of bisphenol-A with epichlorhydrin (DGEBA resins), hydrogenated bisphenol epoxy resins, in particular those derived from the reaction of hydrogenated bisphenol-A with epichlorhydrin (hydrogenated DGEBA resins), and any mixtures thereof.

According to a typical aspect, the first part according to the disclosure comprises from 2 to 100 wt. %, from 2 to 80 wt. %, from 3 to 60 wt. %, from 5 to 5 wt. %, from 10 to 30 wt. %, or even from 15 to 30 wt. %, of the epoxy resin(s), wherein the weight percentages are based on the total weight of the first part. If one or both of the tougheners is present in the second part, a greater amount of the first part will be epoxy resin(s) than if one or both of the tougheners is present in the first part.

### Curing Agents

The second part of the two-part composition contains a curing agent for the epoxy resin.

In some cases, a suitable curing agent comprises thermally activatable curing agents (e.g., initiators). Any thermally activatable curing agents for thermally curable epoxy resins commonly known in the art of structural adhesives may be used in the context of the present disclosure. By “thermally activatable” is meant activatable at a temperature higher than room temperature (i.e., 20-25 degrees Celsius). Suitable thermally activatable curing agents for use herein may be easily identified by those skilled in the art in the light of the present disclosure. Thermally activatable curing agents for use herein may be selected from the group consisting of rapid-reacting curing initiators, latent curing initiators, and any combinations or mixtures thereof. More typically, the thermal curing initiator for use herein may be selected from the group consisting of rapid-reacting thermally-initiated curing initiators, latent thermally-initiated curing initiators, and any combinations or mixtures thereof.

Suitable curing agent(s) may be selected from the group consisting of primary amines, secondary amines, and any combinations or mixtures thereof. In some cases, amines for use as a curing agent for the curable precursor are selected from the group consisting of aliphatic amines, cycloaliphatic amines, aromatic amines, aromatic structures having one or more amino moiety, polyamines, polyamine adducts, dicyandiamides, and any combinations or mixtures thereof.

According to still another advantageous aspect of the disclosure, suitable curing agent(s) for use herein is selected from the group consisting of dicyandiamide, polyamines, polyamine adducts, and any combinations or mixtures thereof. In one preferred embodiment, the curing agent of the epoxy resin for use in the present disclosure is selected to be dicyandiamide.

In some cases, the two-part composition of the present disclosure further comprises a thermal curing accelerator for the epoxy resin. Any thermal curing accelerators for thermally curable resins commonly known in the art of structural adhesives may be formally used in the context of the present disclosure. Suitable thermal curing initiators for use herein may be easily identified by those skilled in the art in the light of the present disclosure.

Curing agents and thermal curing accelerators are well known to those skilled in the art of structural adhesive compositions. Suitable (e.g., thermally activatable) curing agents and thermal curing accelerators for use herein and their methods of manufacturing are amply described for example in EP-A1-2 700 683 (Elgimiabi et al.) and in WO 2017/197087 (Aizawa).

In one advantageous execution, a suitable thermal curing accelerator for use herein is selected from the group consisting of polyamines, polyamine adducts, ureas, substituted urea adducts, imidazoles, imidazole salts, imidazolines, aromatic tertiary amines, and any combinations or mixtures thereof. A suitable thermal curing accelerator may be selected from the group of polyamine adducts, substituted ureas, in particular N-substituted urea adducts.

### First Toughening Agent

The two-part composition of the present disclosure comprises a first toughening agent in the first part, in the second part, or in both parts. It is to be understood that the first toughening agent and the second toughening are not the same but rather are different materials from each other. The terms “first” and “second” (and optionally “third”, “fourth”, “fifth”, etc.) are used merely to distinguish between different toughening agents. First toughening agents which are useful in the present invention are polymeric compounds having both a rubbery phase and a thermoplastic phase such as: graft polymers having a polymerized, diene, rubbery core and a polyacrylate, polymethacrylate shell; graft polymers having a rubbery, polyacrylate core with a polyacrylate or polymethacrylate shell; and elastomeric particles polymerized in situ in the epoxide from free radical polymerizable monomers and a copolymerizable polymeric stabilizer.

Examples of useful toughening agents of the first type include graft copolymers having a polymerized, diene, rubbery backbone or core to which is grafted a shell of an acrylic acid ester or methacrylic acid ester, monovinyl aromatic hydrocarbon, or a mixture thereof, such as disclosed in U.S. Pat. No. 3,496,250 (Czerwinski), incorporated herein by reference. Preferable rubbery backbones comprise polymerized butadiene or a polymerized mixture of butadiene and styrene. Preferable shells comprising polymerized methacrylic acid esters are lower alkyl (C1-C4) substituted methacrylates. Preferable monovinyl aromatic hydrocarbons are styrene, alphamethylstyrene, vinyltoluene, vinylxylene, ethylvinylbenzene, isopropylstyrene, chlorostyrene, dichlorostyrene, and ethylchlorostyrene. It is important that the graft copolymer contain no functional groups that would poison the catalyst.

Examples of useful toughening agents of the second type are acrylate core-shell graft copolymers wherein the core or backbone is a polyacrylate polymer having a glass transition temperature below about 0° C., such as polybutyl acrylate or polyisooctyl acrylate to which is grafted a polymethacrylate polymer (shell) having a glass transition above about 25° C., such as polymethylmethacrylate.

The third class of toughening agents useful in the two-part composition comprises elastomeric particles that have a glass transition temperature (Tg) below about 25° C. before mixing with the other components of the curable precursor. These elastomeric particles are polymerized from free radical polymerizable monomers and a copolymerizable polymeric stabilizer that is soluble in the resins. The free radical polymerizable monomers are ethylenically unsaturated monomers or diisocyanates combined with coreactive difunctional hydrogen compounds such as diols, diamines, and alkanolamines.

Useful toughening agents include core/shell polymers such as methacrylate-butadiene-styrene (MBS) copolymer wherein the core is crosslinked styrene/butadiene rubber and the shell is polymethylacrylate (for example, ACRYLOID KM653 and KM680, available from Rohm and Haas, Philadelphia, PA), those having a core comprising polybutadiene and a shell comprising poly(methyl methacrylate) (for example, KANE ACE M511, M521, B11A, B22, B31, and M901 available from Kaneka Corporation, Houston, TX and CLEARSTRENGTH C223 available from ATOFINA, Philadelphia, PA), those having a polysiloxane core and a polyacrylate shell (for example, CLEARSTRENGTH S-2001 available from ATOFINA and GENIOPERL P22 available from Wacker-Chemie GmbH, Wacker Silicones, Munich, Germany), those having a polyacrylate core and a poly(methyl methacrylate) shell (for example, PARALOID EXL2330 available from Rohm and Haas and STAPHYLOID AC3355 and AC3395 available from Takeda Chemical Company, Osaka, Japan), those having an MBS core and a poly(methyl methacrylate) shell (for example, PARALOID EXL2691A, EXL2691, and EXL2655 available from Rohm and Haas) and the like and mixtures thereof.

In select embodiments, the first toughening agent comprises a core shell rubber.

The first toughening agent is useful in an amount equal to about 1-25 parts by weight, preferably about 3-15 parts by weight, relative to 100 parts by weight of total polymerizable components (including the epoxy resin) of a part of the two-part composition. If the first toughening agent is instead included in both parts of the two-part composition, any proportion of the total amount of the first toughening agent can be included in one part or the other part.

### Second Toughening Agent

The two-part composition of the present disclosure comprises a second toughening agent in the first part, in the second part, or in both parts. Second toughening agents of the present disclosure comprise a free-radically self-polymerizable material represented by the formula:

$${LR}_{q}^{1}$$

wherein each R¹ is independently selected from a functional group represented by the formula:

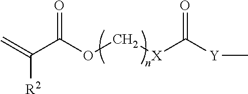

wherein:
each R² is independently hydrogen or methyl;
n is an integer from 1 to 5, inclusive;
   X is O, S, or NH; and
   Y is a single bond or a divalent group represented by the formula:

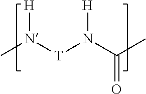

wherein:
   N′ is a nitrogen bonded to the carbonyl carbon of R¹; and
   T is a divalent group selected from the group consisting of a linear alkylene, a cyclic alkylene, an unsubstituted arylene, a substituted arylene, and combinations thereof;
q is an integer of at least 2; and
L is a q-valent organic polymer comprising a monomer unit represented by the formula a):

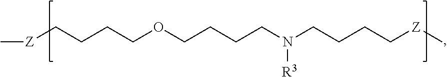

wherein R³ is a hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH.

In select embodiments, R³ is a (meth)acrylate and is a functional group of R¹.

With respect to q-valent organic polymer L, it is understood that L is a homopolymer as opposed to a block copolymer or a random copolymer. For example, a homopolymer L would include only one type of monomer unit, i.e., a), b), c), or d) in the polymer chain. The q-valent organic polymer L typically comprises 100 wt. % of monomer unit a) monomers.

Without wishing to be bound by theory, it is believed that the branches of the free-radically self-polymerizable materials interpenetrate with the epoxy resin but do not react with the epoxy resin.

Free-radically self-polymerizable materials of the present disclosure represented by the formula LR¹_{q} (or L²R¹_{q}, L³R¹_{q}, L⁴R¹_{q}, etc., described below) may be prepared by methods known to those of ordinary skill in the relevant arts and by methods as described, for example, in Cooper, S. L. and Guan, J. (Eds) Advances in Polyurethane Biomaterials, Chapter 4, (Elsevier Ltd., 2016) and Lin et al., “UV-curable low-surface-energy fluorinated poly(urethane-acrylates) s for biomedical applications,” European Polymer Journal, Vol. 44, pp. 2927-2937 (2008). For example, a crosslinker including monomer units represented by the formulas a) and b) may be prepared by the reaction of polyether polyprimary polyamines, either obtained from 3M Company (St. Paul, MN) under the trade designation DYNAMAR HC-1101 or prepared as described in U.S. Pat. No. 3,436,359 (Hubin et al.), with 2-isocyanatoethyl methacrylate (“IEM”).

In some embodiments, the q-valent organic polymer L has a number average molecular weight of from 4000 to 54000 grams per mole versus a polystyrene standard.

A part of the two-part compositions of the present disclosure generally include 2 wt. % or greater of the free-radically self-polymerizable materials described herein, based on the total weight of the combined first part and the second part, 2.25 wt. %, 2.5 wt. %, 2.75 wt. %, 3 wt. %, 3.25 wt. %, 3.5 wt. %, 3.75 wt. %, 4 wt. %, 4.5 wt. %, or 5 wt. % or greater; and 10 wt. % or less, 9 wt. %, 8 wt. %, 7 wt. %, 6 wt. %, or 5 wt. % or less of the free-radically self-polymerizable materials described herein, based on the total weight of the combined first part and the second part.

### Optional Components

The two-part composition according to the present disclosure optionally further comprises additional components, such as a photoinitiator, a reactive diluent, at least one additional toughening agent, and/or conventional additives. Additives may include, for example, tackifiers, plasticizers, dyes, pigments, antioxidants, UV stabilizers, corrosion inhibitors, dispersing agents, wetting agents, adhesion promotors, and fillers.

Fillers useful in embodiments of the present disclosure include, for example, fillers selected from the group consisting of a micro-fibrillated polyethylene, a fumed silica, a talc, a wollastonite, an aluminosilicate clay (e.g., halloysite), phlogopite mica, calcium carbonate, kaolin clay, metal oxides (e.g., barium oxide, calcium oxide, magnesium oxide, zirconium oxide, titanium oxide, zinc oxide), nanoparticle fillers (e.g. nanosilica, nanozirconia), and combinations thereof.

Suitable photoinitiators include for instance a free-radical polymerization initiator for the free-radically self-polymerizable second toughening agent, which may be activated by visible light. Free-radical polymerization initiators for the free-radically self-polymerizable second toughening agent are not particularly limited, as long as they may be activated by visible light. Suitable compounds for use herein may be easily identified by those skilled in the art in the light of the present disclosure.

Preferably, the photoinitiator is activated by light having wavelengths of at least 350 nm. Also, it is preferred that the photoinitiator is activated by light having wavelengths of up to 750 nm. Accordingly, it is preferred that the photoinitiator is activated by light having wavelengths in the range of from 350 nm to 750 nm, preferably from 380 to 700 nm, more preferably from 400 to 650 nm. That is, the photoinitiator may be activated by light having wavelengths in the range of from 380 to 450 nm, and/or from 450 to 485 nm, and/or from 485 to 500 nm, and/or 500 to 565 nm, and/or from 565 to 590 nm, and/or from 590 to 625 nm, and/or from 625 to 700 nm. Particularly preferred herein is blue light, i.e., light having wavelengths from 450 to 485 nm. For instance, the photoinitiator may be activated by light having wavelengths in the range of from (i) 450 to 485 nm, and optionally (ii) from 380 to 450 nm, from 485 to 500 nm, 500 to 565 nm, from 565 to 590 nm, from 590 to 625 nm, and/or from 625 to 700 nm. Thus, other wavelengths of the visible spectrum of light may be utilized.

According to a typical aspect of the disclosure, the photoinitiator of the free-radically self-polymerizable second toughening agent is selected from the group consisting of Norrish type (I) free-radical polymerization initiators, Norrish type (II) free-radical polymerization initiators, and any combinations or mixtures thereof. According to one advantageous aspect of the disclosure, the photoinitiator of the free-radically self-polymerizable second toughening agent is selected from the group consisting of Norrish type (I) free-radical polymerization initiators, and any combinations or mixtures thereof.

According to a more advantageous aspect of the disclosure, the free-radical polymerization initiator of the free-radically self-polymerizable second toughening agent is selected from alpha-diketones and/or phosphinoxides, preferably from camphorquinone, acylphosphinoxide, phenyl-propane-dione, acrylphosphinoxide, dibenzoyl, 1-phenyl-1,2-propandione, and any mixtures and combinations thereof. In some cases, the photoinitiator is preferably camphorquinone.

In one typical aspect, a part of the two-part composition of the disclosure comprises no greater than 10 wt. %, no greater than 8 wt. %, no greater than 6 wt. %, no greater than 5 wt. %, no greater than 4 wt. %, no greater than 2 wt. %, no greater than 1 wt. %, no greater than 0.8 wt. %, no greater than 0.6 wt. %, no greater than 0.5 wt. %, no greater than 0.4 wt. %, no greater than 0.2 wt. %, or even no greater than 0.1 wt. %, of the photoinitiator of the free-radically self-polymerizable second toughening agent, wherein the weight percentages are based on the total weight of the part.

In another typical aspect, a part of the two-part composition of the disclosure comprises from 0.01 to 10 wt. %, from 0.01 to 8 wt. %, from 0.02 to 6 wt. %, from 0.02 to 5 wt. %, from 0.02 to 4 wt. %, from 0.03 to 3 wt. %, from 0.03 to 2 wt. %, from 0.03 to 1.8 wt. %, from 0.03 to 1.6 wt. %, from 0.03 to 1.5 wt. %, from 0.03 to 1.4 wt. %, or even from 0.03 to 1 wt. %, of the photoinitiator of the free-radically self-polymerizable second toughening agent, wherein the weight percentages are based on the total weight of the part.

It may be advantageous to employ at least one reactive diluent in a part of the two-part composition of the present disclosure. Photoinitiators as described herein may be better dissolved in such a reactive diluent than the epoxy resin. Accordingly, it is preferred that any optional free-radical polymerization initiators are dissolved in an at least one reactive diluent before mixing with the other constituents of the curable precursor according to the present disclosure. Reactive diluents are known to the skilled person generally from the technical field of structural adhesives, in particular epoxy-resin based structural adhesives. Preferably, the at least one reactive diluent is selected from glycidyl ethers of linear or branched alkanol, preferably from diglycidyl ethers of linear or branched alkyldiols.

In some cases, the curable precursor contains at least one more toughening agent (e.g., a third toughening agent, a fourth toughening agent, etc.). For instance, an additional toughening agent may comprise a free-radically self-polymerizable material represented by the formula L²R¹_{q}, wherein R¹_{q} is the same as in LR¹_{q} described in detail above and L² is a q-valent organic polymer L² comprising a monomer unit b) represented by the formula:

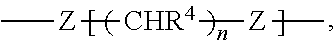

wherein n is an integer from 1 to 5, inclusive, each R⁴ is independently hydrogen or alkyl, and each Z is independently O, S, or NH.

In some cases, an additional toughening agent comprises a free-radically self-polymerizable material represented by the formula L³R¹_{q}, wherein R¹_{q} is the same as in LR¹_{q} described in detail above and L³ is a q-valent organic polymer L³ comprising a monomer unit c) represented by the formula:

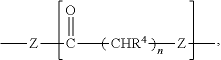

wherein n is an integer from 1 to 5, inclusive, each R⁴ is independently hydrogen or alkyl, and each Z is independently O, S, or NH.

In some cases, an additional toughening agent comprises a free-radically self-polymerizable material represented by the formula L⁴R¹_{q}, wherein R¹_{q} is the same as in LR¹_{q} described in detail above and L⁴ is a q-valent organic polymer L⁴ comprising a monomer unit d) represented by the formula:

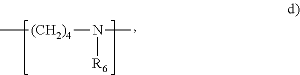

wherein R⁶ is hydrogen, a monomer unit selected from the group consisting of monomer units a)-c) or a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH, where it is understood that monomer units of formula d) are not located at a terminus of L if they are present.

### Methods

In a second aspect, a method of bonding two parts is provided. The method comprises:
a) obtaining the two-part composition according to the first aspect;
b) combining at least a portion of the first part of the two-part composition with at least a portion of the second part of the two-part composition to form a mixture;
c) applying the mixture to a surface of at least one of the two parts; and
d) joining the two parts so that the mixture is positioned between the two parts; and
e) initiating the curing agent for the epoxy resin, thereby obtaining a substantially fully cured structural adhesive composition and bonding the two parts.

The curable precursor is as described in detail above with respect to the first aspect, including any of the various embodiments described therein.

In some cases, prior to step e), the method further comprises partially curing the mixture by initiating a photoinitiator for the free-radically self-polymerizable material by irradiation with actinic light, thereby forming a partially cured precursor of a structural adhesive article comprising a polymeric material resulting from a self-polymerization reaction product of the free-radically self-polymerizable material. Often, initiating a photoinitiator can be done prior to step d), particularly if one or both of the parts lacks transparency through which actinic radiation is able to pass to contact the free-radically self-polymerizable material (e.g., metal parts). The mixture is particularly suitable to perform an overall curing mechanism involving such a two-stage reaction whereby two polymer networks are formed sequentially.

The photoinitiator may be initiated by exposure to actinic radiation, such as by light having wavelengths in the range of from 350 nm to 750 nm as described in detail above with respect to suitable photoinitiators for the mixture. It is particularly advantageous when light of the visible spectrum of the light, in particular blue light, is used to activate the free-radical polymerization initiator, when compared to UV-light activation commonly utilized for initiating cure of adhesive in industrial applications. Not only is the penetration of visible light, in particular blue light, higher, it was also found that the reaction proceeds much faster than with UV-A-light. While the former has the advantage that thicker films may be generated, the latter has the advantage that films may be generally manufactured faster. Also, EHS concerns using UV light at manufacturing sites may be avoided.

In the context of the present disclosure, the expression “substantially fully curing the structural adhesive composition” is meant to express that more than 90 wt. %, more than 95 wt. %, more than 98 wt. %, or even more than 99 wt. % of the overall amount of the thermally curable resin(s) and the free-radically self-polymerizable material are polymerized/cured as the result of the polymerization/curing step(s).

According to an advantageous aspect of the method of bonding two parts, the two parts are metal parts. According to another advantageous aspect, the method of bonding two parts is for hem flange bonding of metal parts, wherein:
the partially cured precursor is shaped in the form of an elongated film;
the partially cured precursor film has a first portion near a first end of the precursor film and a second portion near the second end opposite to the first end of the precursor film;
the first metal part comprises a first metal panel having a first body portion and a first flange portion along a margin of the first body portion adjacent a first end of the first body portion;
the second metal part comprises a second metal panel having a second body portion and a second flange portion along a margin of the second body portion adjacent a second end of the second body portion;
   wherein the method comprises the steps of:
a) adhering the partially cured precursor film to the first metal panel or second metal panel, whereby following adhering and folding, a metal joint is obtained wherein the partially cured precursor film is folded such that:
   i. the first portion of the partially cured precursor film is provided between the second flange of the second metal panel and the first body portion of the first metal panel, and
   ii. the second portion of the partially cured precursor film is provided between the first flange of the first metal panel and the second body portion of the second metal panel; and
b) substantially fully curing the partially cured precursor by initiating the thermal curing initiator for the thermally curable resin, thereby obtaining a substantially fully cured (hybrid) structural adhesive composition and bonding the metal joint.

According to a typical aspect of the partially cured precursor according to the disclosure, the polymeric material comprising the self-polymerization reaction product of the polymerizable material comprising the free-radically self-polymerizable material is substantially fully polymerized and has in particular a degree of polymerization of more than 90%, more than 95%, more than 98%, or even more than 99%.

The elongated film shape is one conventional and convenient shape for the structural adhesive to be pre-applied on a selected substrate, in particular a liner, until further processing.

In one particular aspect of the disclosure, the elongated film for use herein has a thickness greater than 500 micrometers, greater than 600 micrometers, greater than 700 micrometers, greater than 800 micrometers, greater than 900 micrometers, or even greater than 1000 micrometers.

In another particular aspect of the disclosure, the elongated film for use herein has a thickness no greater than 500 micrometers, no greater than 400 micrometers, no greater than 300 micrometers, no greater than 200 micrometers, no greater than 100 micrometers, or even greater than 50 micrometers.

Although the elongated film shape may be convenient in many different applications, this specific shape is not always satisfactory for adhesively bond assemblies provided with complex three-dimensional configurations or topologies, in particular when provided with challenging bonding areas or surfaces.

Accordingly, the curable precursor or the partially or fully cured (hybrid) structural adhesive composition of the disclosure may—in another aspect—be shaped in the form of a three-dimensional object. Suitable three-dimensional object shapes for use herein will broadly vary depending on the targeted bonding application and the specific configuration of the assembly to bond, in particular the bonding area. Exemplary three-dimensional object shapes for use herein will be easily identified by those skilled in the art in the light of the present disclosure. According to one exemplary aspect of the present disclosure, the three-dimensional object has a shape selected from the group consisting of circular, semi-circular, ellipsoidal, square, rectangular, triangular, trapezoidal, polygonal shape, or any combinations thereof. In the context of the present disclosure, the shape of the three-dimensional object is herein meant to refer to the shape of the section of the three-dimensional object according to a direction substantially perpendicular to the greatest dimension of the three-dimensional object.

According to still another advantageous aspect of the method of bonding two parts, a side of a first edge portion of the first metal part is folded back and a hem flange structure is formed so as to sandwich the second metal part, and the curable precursor or the partially cured precursor as described above is disposed so as to adhere at least the first edge portion of the first metal part and a first surface side of the second metal part to each other.

Methods of bonding two parts, in particular for hem flange bonding of metal parts, are well known to those skilled in the art of structural adhesive compositions. Suitable methods of bonding two parts for use herein are amply described e.g., in EP-A1-2 700 683 (Elgimiabi et al.) and in WO 2017/197087 (Aizawa).

In yet another aspect, the present disclosure relates to a composite article comprising a curable precursor or a partially or fully cured (hybrid) structural adhesive composition as described above applied on at least part of the surface of the article. Suitable surfaces and articles for use herein are not particularly limited. Any surfaces, articles, substrates and material commonly known to be suitable for use in combination with structural adhesive compositions may be used in the context of the present disclosure.

In a typical aspect, the article for use herein comprises at least one part, in particular a metal or a composite material part. In an advantageous aspect, the composite article according to the disclosure is used for body-in-white bonding applications for the automotive industry, in particular for hem flange bonding of parts, more in particular metal or composite material parts; and for structural bonding operations for the aeronautic and aerospace industries.

In a particular aspect of the present disclosure, the substrates, parts and surfaces for use in these methods comprise a metal selected from the group consisting of aluminum, steel, iron, and any mixtures, combinations or alloys thereof. More advantageously, the substrates, parts and surfaces for use herein comprise a metal selected from the group consisting of aluminum, steel, stainless steel and any mixtures, combinations or alloys thereof. In a particularly advantageous execution of the present disclosure, the substrates, parts and surfaces for use herein comprise aluminum.

It has yet surprisingly been discovered that, in some executions, the curable precursor as described above is suitable for manufacturing structural adhesive compositions provided with excellent characteristics and performance as to adhesion to oily contaminated substrates, such as stainless steel and aluminum.

### SELECT EMBODIMENTS OF THE PRESENT DISCLOSURE

In a first embodiment is provided a two-part composition. The two-part composition comprises (1) a first part comprising an epoxy resin; optionally a first toughening agent; and optionally a second toughening agent comprising a free-radically self-polymerizable material represented by the formula: LR¹_{q}, wherein each R¹ is independently selected from a functional group represented by the formula:

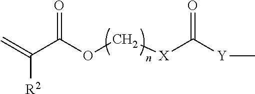

wherein each R² is independently hydrogen or methyl; n is an integer from 1 to 5, inclusive; X is O, S, or NH; and Y is a single bond or a divalent group represented by the formula:

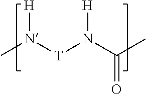

wherein N′ is a nitrogen bonded to the carbonyl carbon of R¹; and T is a divalent group selected from the group consisting of a linear alkylene, a cyclic alkylene, an unsubstituted arylene, a substituted arylene, and combinations thereof; q is an integer of at least 2; and L is an q-valent organic polymer comprising a monomer unit represented by the formula:

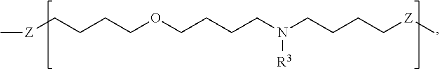

wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH; and
(2) a second part comprising a curing agent for the epoxy resin; optionally the first toughening agent; and optionally the second toughening agent, with the provisos that the first toughening agent is present in at least one of the first part or the second part and the second first toughening agent is present in at least one of the first part or the second part.

In a second embodiment is provided a two-part composition according to the first embodiment, wherein at least one of the first part of the second part further comprises at least one reactive diluent.

In a third embodiment is provided a two-part composition according to the second embodiment, wherein the at least one reactive diluent comprises a glycidyl ether of a linear or branched alkanol.

In a fourth embodiment is provided a two-part composition according to any of the first through third embodiments, wherein R³ is a (meth)acrylate and is a functional group of R¹.

In a fifth embodiment is provided a two-part composition according to any of the first through fourth embodiments, wherein the first toughening agent comprises a core shell rubber.

In a sixth embodiment is provided a two-part composition according to any of the first through fifth embodiments, wherein the curing agent for the epoxy resin is selected from the group consisting of primary amines, secondary amines, and any combination thereof.

In a seventh embodiment is provided a two-part composition according to any of the first through sixth embodiments, wherein the q-valent organic polymer L has a number average molecular weight of from 4000 to 54000 grams per mole versus a polystyrene standard.

In an eighth embodiment is provided a two-part composition according to any of the first through seventh embodiments, further comprising a third toughening agent comprising a free-radically self-polymerizable material represented by the formula L²R¹_{q}, wherein R¹_{q} is the same as in LR¹_{q} and L² is a q-valent organic polymer L² comprising a monomer unit b) represented by the formula:

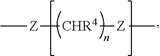

wherein n is an integer from 1 to 5, inclusive, each R⁴ is independently hydrogen or an alkyl, and each Z is independently O, S, or NH.

In a ninth embodiment is provided a two-part composition according to any of the first through eighth embodiments, further comprising a fourth toughening agent comprising a free-radically self-polymerizable material represented by the formula L³R¹_{q}, wherein R¹_{q} is the same as in LR¹_{q} and L³ is a q-valent organic polymer L³ comprising a monomer unit c) represented by the formula:

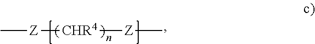

wherein n is an integer from 1 to 5, inclusive, each R⁴ is independently hydrogen or an alkyl, and each Z is independently O, S, or NH.

In a tenth embodiment is provided a two-part composition according to any of the first through ninth embodiments, further comprising a fifth toughening agent comprising a free-radically self-polymerizable material represented by the formula L⁴R¹_{q}, wherein R¹_{q} is the same as in LR¹_{q} and L⁴ is a q-valent organic polymer L⁴ comprising a monomer unit d) represented by the formula:

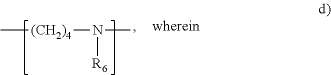

R⁶ is hydrogen, a monomer unit selected from the group consisting of monomer units a)-c) and a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH.

In an eleventh embodiment is provided a two-part composition according to any of the first through tenth embodiments, wherein the q-valent organic polymer L comprises 100 wt. % of monomer unit a) monomers.

In a twelfth embodiment is provided a two-part composition according to any of the first through eleventh embodiments, wherein the second toughener is present in an amount of up to 10 wt. %, based on the total weight of the combined first part and second part.

In a thirteenth embodiment is provided a method of bonding two parts. The method comprises a) obtaining the two-part composition of any of the first through twelfth embodiments; b) combining at least a portion of the first part of the two-part composition with at least a portion of the second part of the two-part composition to form a mixture; c) applying the mixture to a surface of at least one of the two parts; d) joining the two parts so that the mixture is positioned between the two parts; and e) initiating the curing agent for the epoxy resin, thereby obtaining a substantially fully cured structural adhesive composition and bonding the two parts.

In a fourteenth embodiment is provided a method according to the thirteenth embodiment, further comprising, prior to step e), partially curing the mixture by initiating a photoinitiator for the free-radically self-polymerizable material by irradiation with actinic light, thereby forming a partially cured precursor of a structural adhesive article comprising a polymeric material resulting from the self-polymerization reaction product of the free-radically self-polymerizable material.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

Materials Used in the Examples

| Abbreviation | Description and Source |
|---|---|
| SA9822 | is a two-part epoxy structural adhesive |
| | for automotive applications, commercially |
| | available from 3M Deutschland GmbH, Neuss |
| HC1101/IEM | is a free-radically self-polymerizable |
| | intermediate prepared generally according |
| | to the procedure described in Preparative |
| | Example 1 of WO 2020/250154 |

### Preparation of the Formulations for Testing:

### Part B—Base Resin Preparation:

The B-Part of 3M SA9822 was taken and placed in a beaker and briefly heated up to around 60-70° C. in an oven. HC1101/IEM was warmed up to 80° C. in an oven until it liquified. The liquid polymer was then added to the warm B-part and the mixture was mixed in a high-speed mixer (DAC 150.1 FVZ Speedmixer, Hauschild Engineering, Germany) at 3500 rpm for 1 minute. The mixture was allowed to cool down and the process was repeated several times until it became thoroughly homogenous.

### Part A—Hardener Preparation:

Part A was taken as provided and not further modified. The wt. % of the examined modified two-component formulations are shown in Table 1.

TABLE 1

Formulation

| | Comparative Example 1 | Example 2 |
|---|---|---|
| Raw materials | [wt. %] | [wt. %] |
| SA9822 Part B | 80.00 | 76.00 |
| HC1101/IEM | 0.00 | 5.00 |
| SA9822 Part A | 20.00 | 19.00 |

### Impact Peel Strength According to DIN EN ISO 11343:

### Preparation of the Test Samples for Impact Peel Tests:

Impact peel performance was determined according to DIN EN ISO 11343 using a Zwick HIT450P pendulum test machine (commercially available by Zwick GmbH & Co. KG, Ulm, Germany). For the preparation of the impact peel test assembly, the test specimens were cleaned with n-heptane. Parts A and B were mixed by hand in a small aluminum pan according to the amounts shown in Error! Reference source not found. The material was subsequently put onto the surface of the first test panel.

The second test panel surface was then bonded to the first forming a bonded joint of 30 mm. The samples were fixed together with clamps and first stored at room temperature for 12 hours, and then placed into an air circulating oven for 30 minutes at 180° C. The next day, the samples were tested. The substrates were bonded over a length of 30 mm and the free arms of the specimen were clamped. A wedge was drawn through the bonded portion of the specimen with a test rate of 2 m/s. The result was averaged and reported in N/mm indicating the adhesive resistance to crack growth influenced by different temperatures. Per test eight samples are prepared; four of which were tested at room temperature, four at −30° C. Test results for the formulations are shown in Table 2.

TABLE 2

| | Impact peel [N/mm] | Impact peel |
|---|---|---|
| Formulation | @room temperature | [N/mm] @−30° C. |
| Comparative | 7.88 | 0.57 |
| Example 1 | 7.91 | 0.46 |
| | 8.24 | 0.66 |
| | 8.22 | 0.53 |
| | average: 8.06 | average: 0.55 |
| Example 2 | 8.06 | 1.26 |
| | 8.82 | 1.51 |
| | 7.62 | 1.42 |
| | 8.85 | 1.27 |
| | average: 8.34 | average: 1.37 |

As can be seen from the results shown in Table 2, the structural adhesive modified according to the present disclosure provides improved impact peel strength performance on clean substrates at low temperatures when compared to the unmodified adhesive formulated without the second toughening agent comprising a free-radically self-polymerizable material. For the example given the performance in impact peel strength at −30° C. of the modified material compared to the unmodified structural adhesive is almost 2.5 times higher.

### Prophetic Example 3—Structural Adhesive Including Photoinitiator

A structural adhesive can be prepared according to the procedure described above for Example 2 except that a photoinitiator (e.g., 0.01 to 10 wt. % camphorquinone available from Sigma-Aldrich, St. Louis, MO) is included in the Part B. Once the liquid polymer and warm B-part are homogeneously mixed and allowed to cool, the photoinitiator is added and mixed in at 3500 rpm for 1 minute.

Impact peel strength of the structural adhesive including a photoinitiator is determined according to the “Impact peel strength according to DIN EN ISO 11343” procedure described above except that after the Parts A and B are mixed and put onto the surface of the first test panel, the material is next irradiated with a blue light LED (10 cm×10 cm; 460 nm; Dr. Göbel Opsitec) for 15 s after application on the first substrate, before closing the bondline.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A two-part composition comprising:
(1) a first part comprising:
an epoxy resin;
optionally a first toughening agent; and
optionally a second toughening agent comprising a free-radically self-polymerizable material represented by the formula:
LR¹_{q}
wherein each R¹ is independently selected from a functional group represented by the formula: 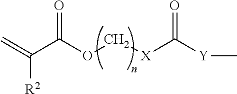
wherein:
each R² is independently hydrogen or methyl;
n is an integer from 1 to 5, inclusive;
X is O, S, or NH; and
Y is a single bond or a divalent group represented by the formula: 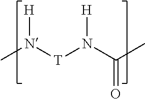
wherein:
N′ is a nitrogen bonded to the carbonyl carbon of R¹; and
T is a divalent group selected from the group consisting of a linear alkylene, a cyclic alkylene, an unsubstituted arylene, a substituted arylene, and combinations thereof;
q is an integer of at least 2; and
L is an q-valent organic polymer comprising a monomer unit represented by the formula: 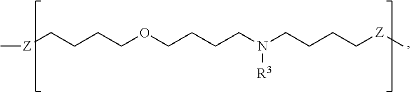
wherein R³ is hydrogen, a (meth)acrylate group, or a Z-terminated alkyl or heteroalkylene chain, wherein each Z-terminated chain may independently include a linkage selected from the group consisting of a secondary amino linkage, a tertiary amino linkage, an ether linkage, and combinations thereof, and wherein each Z is independently O, S, or NH; and
(2) a second part comprising:
a curing agent for the epoxy resin;
optionally the first toughening agent; and
optionally the second toughening agent,
with the provisos that the first toughening agent is present in at least one of the first part or the second part and the second toughening agent is present in at least one of the first part or the second part.

2. The two-part composition of claim 1, wherein at least one of the first part of the second part further comprises at least one reactive diluent.

3. The two-part composition of claim 2, wherein the at least one reactive diluent comprises a glycidyl ether of a linear or branched alkanol.

4. The two-part composition of claim 1, wherein R³ is a (meth)acrylate and is a functional group of R¹.

5. The two-part composition of claim 1, wherein the first toughening agent comprises a core shell rubber.

6. The two-part composition of claim 1, wherein the curing agent for the epoxy resin is selected from the group consisting of primary amines, secondary amines, and any combination thereof.

7. The two-part composition of claim 1, wherein the q-valent organic polymer L has a number average molecular weight of from 4000 to 54000 grams per mole versus a polystyrene standard.

8. The two-part composition of claim 1, further comprising a third toughening agent comprising a free-radically self-polymerizable material represented by the formula L²R¹_{q}, wherein R¹_{q} is the same as in LR¹_{q} and L² is a q-valent organic polymer L² comprising a monomer unit b) represented by the formula: 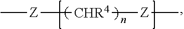
wherein n is an integer from 1 to 5, inclusive, each R⁴ is independently hydrogen or an alkyl, and each Z is independently O, S, or NH.

9. The two-part composition of claim 1, further comprising a fourth toughening agent comprising a free-radically self-polymerizable material represented by the formula L³R¹_{q}, wherein R¹_{q} is the same as in LR¹_{q} and L³ is a q-valent organic polymer L³ comprising a monomer unit c) represented by the formula: 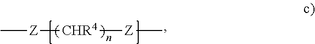
wherein n is an integer from 1 to 5, inclusive, each R⁴ is independently hydrogen or an alkyl, and each Z is independently O, S, or NH.

10. The two-part composition of claim 1, further comprising a fifth toughening agent comprising a free-radically self-polymerizable material represented by the formula L⁴R¹_{q}, wherein R¹_{q} is the same as in LR¹_{q} and L⁴ is a q-valent organic polymer L⁴ comprising a monomer unit d) represented by the formula: 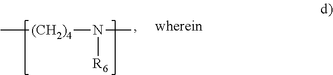
R⁶ is hydrogen, a monomer unit selected from the group consisting of monomer units a)-c) and a Z-terminated alkyl chain, wherein the Z-terminated alkyl chain may include a linkage selected from the group consisting of a secondary amino linkage, a tertiary amino linkage, an ether linkage, and combinations thereof, and wherein Z is O, S, or NH.

11. The two-part composition of claim 1, wherein the q-valent organic polymer L comprises 10 wt. % to 20 wt. % of monomer unit a) monomers.

12. The two-part composition of claim 1, wherein the second toughener is present in an amount of up to 10 wt. %, based on the total weight of the combined first part and second part.

13. A method of bonding two parts, the method comprising:
a) obtaining the two-part composition of claim 1;
b) combining at least a portion of the first part of the two-part composition with at least a portion of the second part of the two-part composition to form a mixture;
c) applying the mixture to a surface of at least one of the two parts; and
d) joining the two parts so that the mixture is positioned between the two parts; and
e) initiating the curing agent for the epoxy resin, thereby obtaining a substantially fully cured structural adhesive composition and bonding the two parts.

14. The method of claim 13, further comprising, prior to step e), partially curing the mixture by initiating a photoinitiator for the free-radically self-polymerizable material by irradiation with actinic light, thereby forming a partially cured precursor of a structural adhesive article comprising a polymeric material resulting from the self-polymerization reaction product of the free-radically self-polymerizable material.
